(19) United States
(12) Patent Application Publication
(10) Pub. No.: US 2007/0097056 A1
(43) Pub. Date: May 3, 2007

(54) DRIVING METHOD AND DATA DRIVING CIRCUIT OF A DISPLAY

(75) Inventor: Der-Yuan Tseng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/531,684

(22) Filed: Sep. 13, 2006

(30) Foreign Application Priority Data
Oct. 28, 2005 (TW) 94137767

(51) Int. Cl. G09G 3/36

(52) U.S. Cl. 345/96

(57) ABSTRACT

A driving method and data driving circuit of display is provided. A frame is divided into a first field and a second field, and respectively driving a first and a second part of those data lines within the first and second field. Sequentially driving a first part of the data lines corresponding to the first field and driving a second part of the data lines corresponding to the second field. While said data lines are driving, every two adjacent pixels are respectively applied with a first common voltage with a first polarity and applied with a second common voltage with a second polarity within a time period of the frame, where the first polarity is opposite to the second polarity, and the first part and the second part of the data lines are interlaced arrangement.

### CROSS-REFERENCE TO RELATED APPLICATION

This application claims the priority benefit of Taiwan application serial no. 94137767, filed Oct. 28, 2005. All disclosure of the Taiwan application is incorporated herein by reference.

### BACKGROUND OF THE INVENTION

1. Field of Invention

The present invention relates to a driving method and a data driving circuit of a display. More particularly, the present invention relates to a driving method and a data driving circuit of a display using alternating current common electrode voltage (AC Vcom) and a dot inversion manner for driving.

2. Description of Related Art

As generally known in the art, a function of a display is displaying images to audiences, and quality of images shown in the display will influence feeling of the audiences. Audiences usually consider the display, such as a liquid crystal display, to a bad display if they have bad feeling about the displayed images which have problems like flicker and crosstalk. Flicker and crosstalk problems make color edge of the images not sharp enough to make the images clear, which burden the audiences if they try to look at the images displayed. Factors that influence the level of flicker and crosstalk are driving method and data driving circuit of the display.

A common electrode voltage (“Vcom”, as shown in FIG. 1) of a driving circuit in a display is generally of two types, a first one using a direct current (DC) source and another one using an alternating current (AC) source. In the case of using AC Vcom, a source driver can reduce its output voltage, therefore a lower operation voltage is used, the low-voltage process is adopted and power consumption is reduced thereby. However, in consideration of applications, a manner of polarity changing in the liquid crystal display can generally be only adopted with a frame inversion manner or a row inversion manner. The method of polarity changing for the frame inversion is shown in FIG. 2, and waveform of the Vcom is shown in FIG. 4 and FIG. 5. With reference to a frame 1 of FIG. 4, a waveform of Vcom forms polarity, which is all positive in the whole frame, as shown in frame 1 of FIG. 2. With reference to frame 2 of FIG. 5, a waveform of Vcom forms polarity, which is all negative in the whole frame, as shown in frame 2 of FIG. 2. Although it achieves the purpose of reducing power consumption, it also causes problems, such as flicker and crosstalk, which have bad influence to image quality.

Method of the polarity change of the row inversion is shown in FIG. 3, and the corresponding waveform of Vcom is shown in FIG. 4 and in FIG. 5. With reference to frame 1 of FIG. 4, a waveform of Vcom forms polarity, which is all positive in odd lines and all negative in even lines, as shown in frame 1 of FIG. 3. With reference to frame 2 of FIG. 5, a waveform of Vcom forms polarity, which is all negative in odd lines and all positive in even lines, as shown in frame 2 of FIG. 3. Although the row inversion partially overcomes shortcomings of the frame inversion, the improvement is occasionally insufficient for images requiring higher quality. The adoption of method of dot inversion polarity change solves problems mentioned above. However, a conventional source driving circuit and its control method cannot complete the function of dot inversion with using the AC Vcom.

### SUMMARY OF THE INVENTION

The present invention provides a driving method and a data driving circuit of display thereof capable of obtaining a display image by using a dot inversion under a AC Vcom.

The driving method of the present invention divides a first frame into a first field and a second field, and driving data lines of a first part in the first field and driving data lines of a second part in the second field.

The data driving circuit of the present invention includes a data processing circuit. The data processing circuit includes a plurality of output terminals, a plurality of multiplexers (MUXs) and a control unit. The data process circuit receives display data and outputs the display data to the output terminals, input terminals of each of the MUXs one-on-one coupled to the output terminals. Each MUX includes a first output terminal and a second output terminal, in which the first output terminal and the second output terminal are coupled to two adjoining data-lines. The control unit provides a control signal to the MUXs to choose from the first output terminal and the second output terminal as the terminal through which the MUXs outputs display data.

The present invention uses a new driving method and new data driving circuit, in which a frame is divided into two fields, and data lines corresponding to both of the fields are respectively driven to reduce flicker and crosstalk and solves quality problem. The present invention also overcomes the problem that the conventional source driver circuit and control method cannot achieve a driving method of a dot inversion with using AC Vcom. The data driving circuit of the present invention drives the data lines in a half of a display panel in one field time, therefore only half of the conventional driving circuits is required, which reduce necessary circuit and the cost.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional liquid crystal display.

FIG. 2 shows general polarity change in frame inversion.

FIG. 3 shows general polarity change in raw inversion.

FIG. 4 and FIG. 5 show voltage waveform of Vcom in frame inversion and in raw inversion.

FIG. 6 shows polarity change in the dot inversion according to the embodiment of the present invention.

FIG. 7 shows the voltage waveform of Vcom according to the embodiment of the present invention.

FIG. 8 shows the block diagram of source driver according to the embodiment of the present invention.

FIG. 9 is a block diagram of a conventional source driver.

FIG. 10 shows the mux inner block diagram of source driver according to the embodiment of the present invention.

### DESCRIPTION OF EMBODIMENTS

In order to solve problems that conventional source driver circuit and its control method cannot achieve function of dot inversion with using AC Vcom, and to overcome image quality problems such as flicker and crosstalk, the present invention provides a driving method and a data driving circuit different from the conventional ones. In the following, detailed description along with the accompanied drawings is given to better explain preferred embodiments of the present invention.

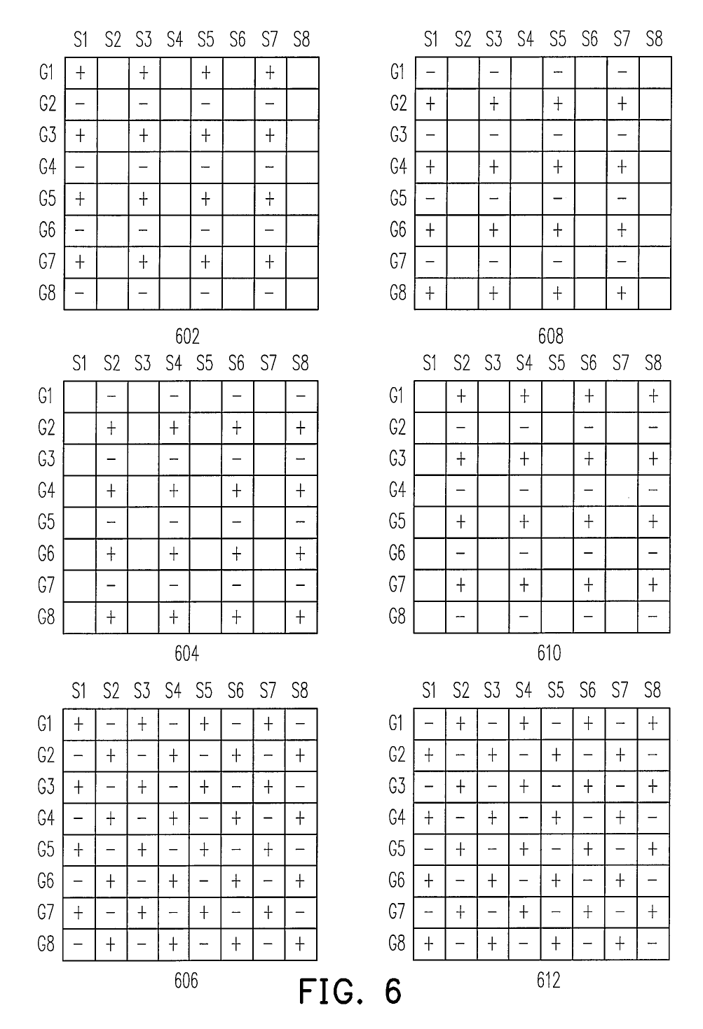

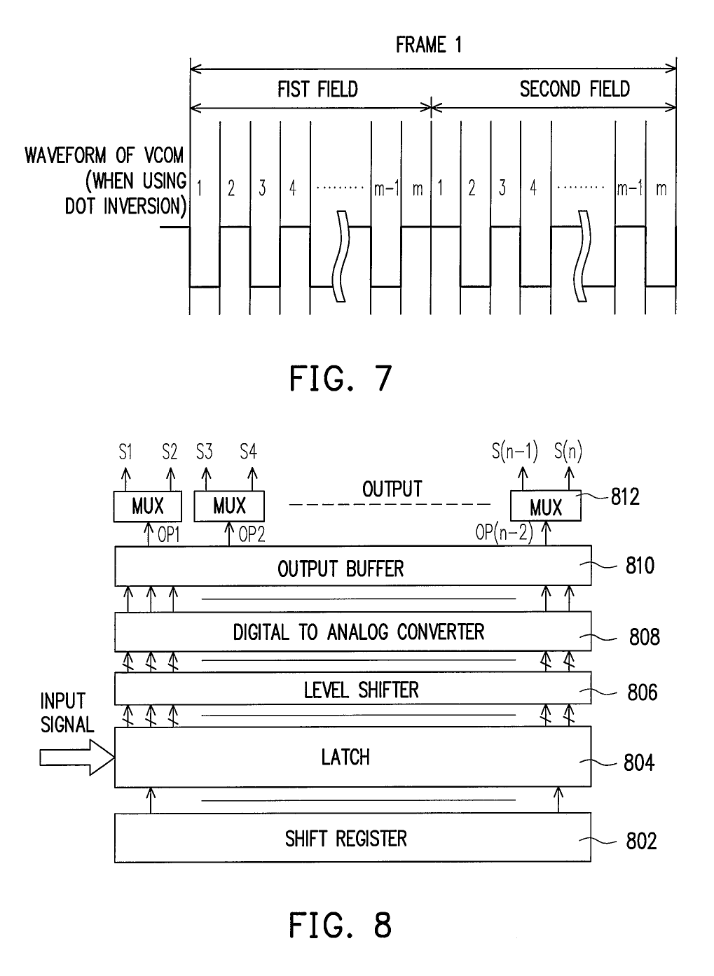

As shown in FIG. 6 and FIG. 7, the present invention uses dot inversion polarity change as a control method to accomplish dot inversion under AC Vcom. For explanation, a portion of a data lines and gate lines are shown, but is not limited to. With reference to a voltage waveform of Vcom as shown in FIG. 7, a frame 1 is divided into a first field and a second field. With reference to FIG. 6, a source driver drives odd data lines such as S1, S3, S5, and S7 of display as shown in the first field, and a Vcom voltage waveform which changes polarity during every horizontal line as shown in FIG. 7. The polarity characteristic 602 between Vcom and image data stored in pixels in the first filed of the first frame is shown in FIG. 6. The symbol “+” represents the image data voltage higher than Vcom and the symbol “−” represents image data voltage lower than Vcom.

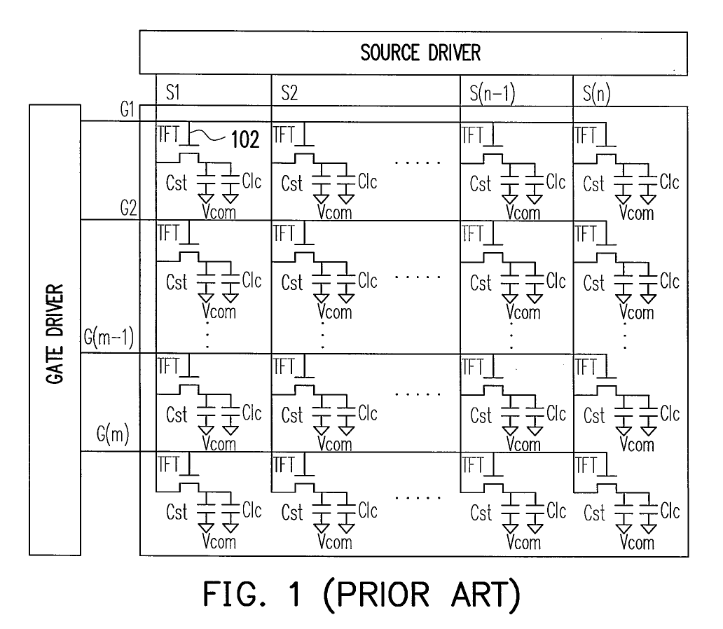

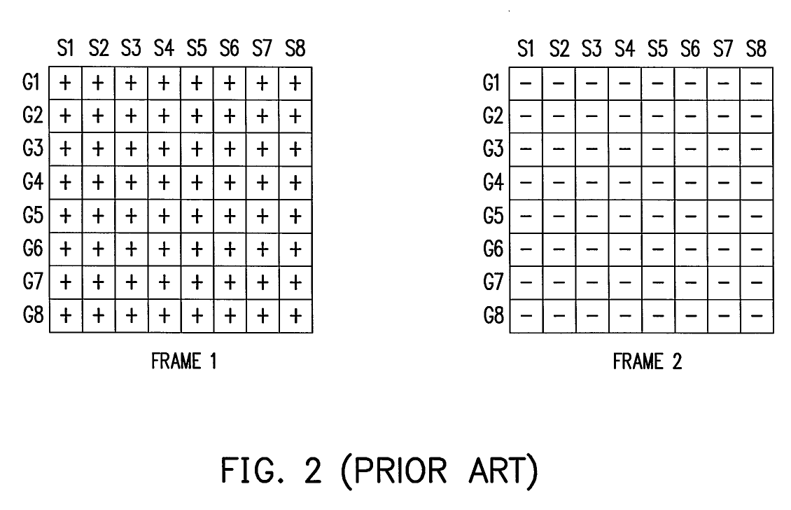

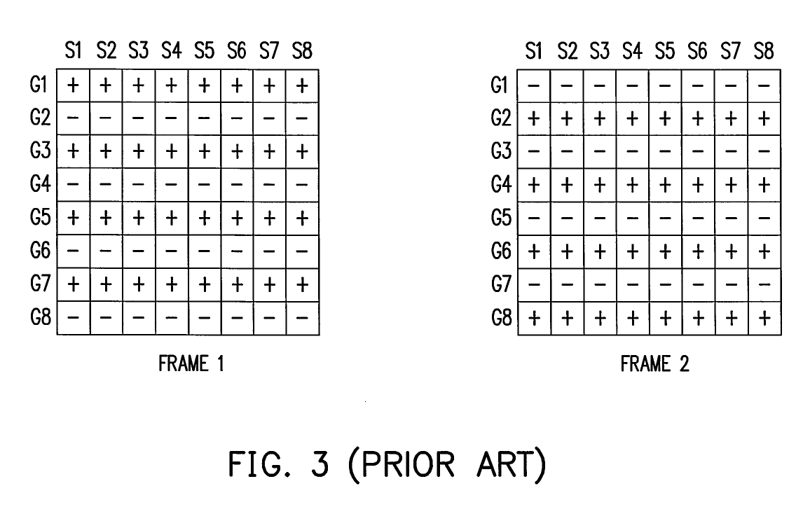

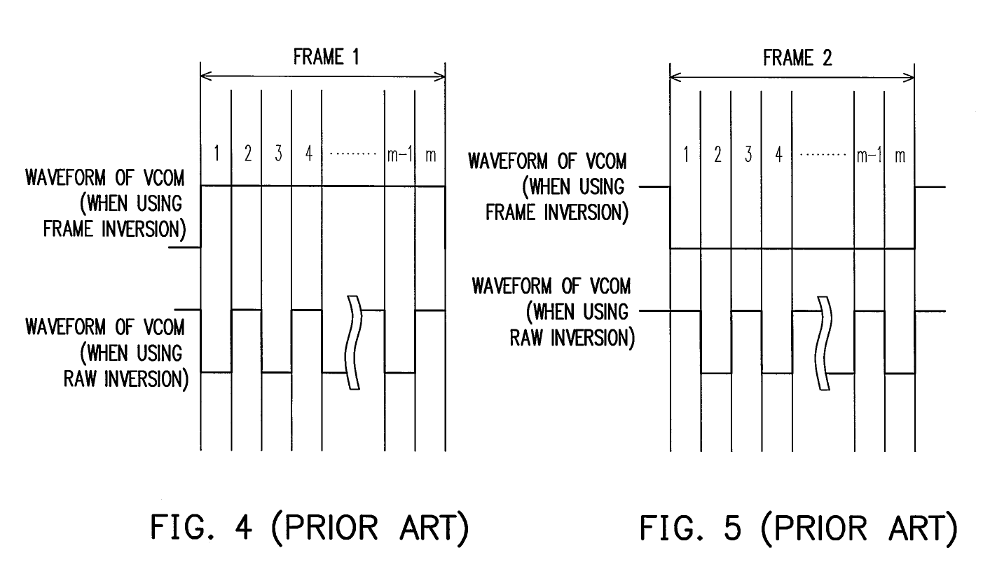

The source driver drives even data lines S2, S4, S6, and S8 of the display in the second field of the first frame, and a Vcom voltage waveform which changes polarity during every horizontal line is shown in FIG. 7, which is opposite to Vcom polarity in the first field. The polarity characteristic 604 between Vcom and image data stored in pixels in the second field of the first frame is shown in FIG. 6. The first frame has polarity characteristic 606 between Vcom and image data stored in pixels, as shown in FIG. 6, after combining the polarity characteristic 602 in the first field and the polarity characteristic 604 in the second field, and the number of thin film transistors (as the thin film transistors 102 as shown FIG. 1) is only half of total thin film transistors in one frame. Then a next frame (the second frame) is also divided into a first field and a second field. A source driver also drives odd data lines S1, S3, S5, and S7 of display in the first field, and a voltage phase of Vcom of which is opposite to the voltage phase of the Vcom in the first field of the first frame, but is the same as the second field as shown in FIG. 7. That means Vcom has polarity opposite to polarity in the first field of the previous frame though it changes polarity during every horizontal line in the same way. The polarity characteristic between Vcom and image data stored in pixels in the first field of the second frame is shown as a reference number 608 in FIG. 6. In the second field, the source driver drives even data lines S2, S4, S6, and S8 of display and changes polarity during every horizontal line, same as the first field as shown in FIG. 7, but has opposite voltage phase of Vcom to the Vcom in the second field of the first frame. The polarity characteristic between Vcom and image data stored in pixels in the second frame is shown as a reference number 610 in FIG. 6. Then the second frame has polarity characteristic 612 between Vcom and image data stored in pixels, as shown in FIG. 6. The number of thin film transistor driven is also half of total thin film transistors in a frame.

FIG. 8 is a schematic diagram showing a source driver according to one embodiment of the present invention. As shown in FIG. 8, the source driver includes a shift register 802, a latch 804, a level shifter 806, a digital to analog converter 808, an output buffer 810 and n/2 one-to-two type multiplexers (MUXs) 812, where n represents the number of output terminals S1-S(n) of a conventional source driver as shown in FIG. 1. It means that the source driver of the embodiment requires only half of the output buffers than the conventional one.

In the source driver, output terminals of the shift register 802 are coupled to input terminals of the latch 804, output terminals of the latch 804 are coupled to input terminals of the level shifter 806, output terminals of the level shifter 806 are coupled to input terminals of the digital to analog converter 808, output terminals of the digital to analog converter 808 are coupled to input terminals of the output buffer 810, and output terminals of the output buffer 810 are coupled to input terminals of the one-to-two MUXs 812.

While the output buffer 810 outputs buffered signals OP1, OP2 . . . OP(N/2) to the MUXs 812, the MUXs 812 decide to output the odd output signals to odd-numbered output terminals S1,S3 . . . S(n-1) or the even-numbered output terminals S2,S4 . . . S(n) according to a control signal synchronous to a field switching rate to accomplish dot inversion.

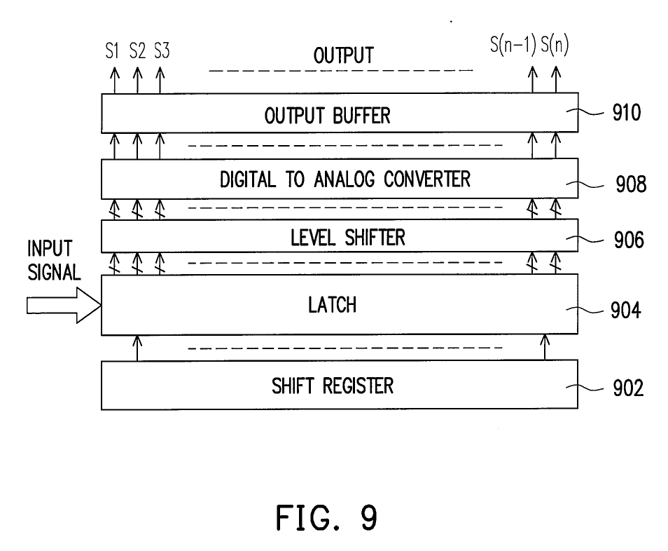

FIG. 9 is a schematic diagram showing the circuit block of a conventional source driver. As shown in FIG. 9, the source drivers includes a shift register 902, a latch 904, a level shifter 906, a digital to analog converter 908, and output buffers 910. The output buffer 910 has output terminals S1, S2, . . . , S(n), where n represents a number of total output terminals of the output buffers 910 which are also the same as the output terminals S1-S(n) of the conventional source driver shown in FIG. 1.

Output terminals of the shift register 902 are coupled to input terminals of the latch 904, output terminals of the latch 904 are coupled to input terminals of the level shifter 906, output terminals of the level shifter 906 are coupled to input terminals of the digital to analog converter 908, and output terminals of the digital to analog converter 908 are coupled to input terminals of the output buffer 910. The conventional source driver circuit does not have the control signal synchronous to field switching rate and MUXs which can decide to output the odd output signals S1,S3 . . . S(n-1) or the even output signals S2,S4 . . . S(n) according to the control signal, as described in the embodiment of the present invention, therefore the conventional source driver cannot accomplish dot inversion when the output buffer output signals directly.

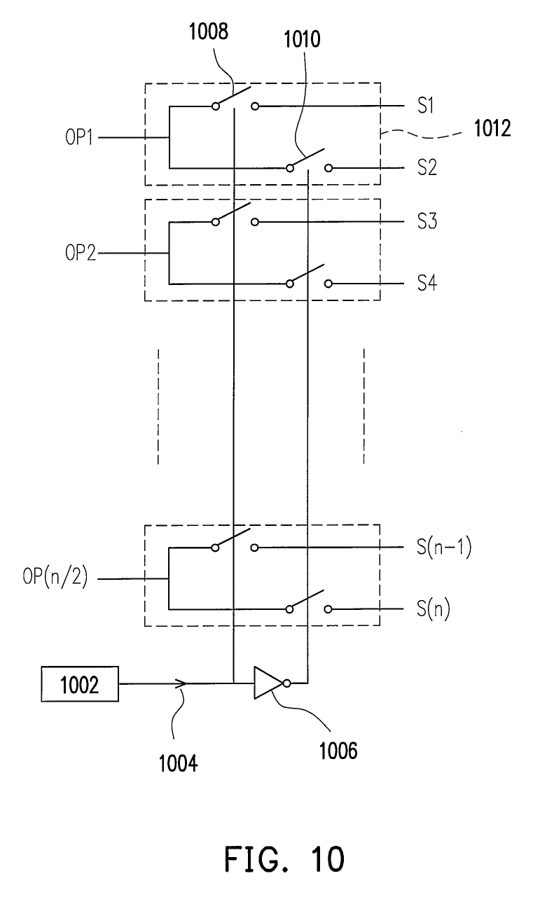

An embodiment of a multiplexer in a source driver according to the preferred embodiment of the present invention is shown in FIG. 10. As shown in FIG. 10, circuits of the source driver includes a control unit 1002, an inverter 1006, and n/2 multiplexers 1012, where n represents the number of outputs required for the source driver. Each of the multiplexer 1012 includes a first switches 1008 and a second switches.

As shown in FIG. 10, each dash line frame represents one switching unit 1012, and input terminals of the multiplexer 1012, from OP1 to OP(n/2) respectively corresponds to output terminals of the output buffer, for example, OP1 to OP(n/2) as shown in FIG. 8. The output terminals of multiplexer 1012, from S1 to S(n) also respectively correspond to the output terminals (from S1 to S(n)) of multiplexers 812 in FIG. 8. The multiplexer 1012 includes switches respectively coupled between each input terminal and each output terminal. The control unit 1002 controls a half of the switches in all multiplexer 1012, for example, odd-numbered output terminals S1, S3 . . . S(n-1). The control unit 1002 also alternately controls the other half of the switches in all multiplexer 1012 through the outputs of the inverter 1006, for example, the even-numbered output terminals S2, S4 . . . S(n).

When the control unit 1002 outputs a control signal 1004 synchronous with the field switching rate to the inverter 1006, each multiplexer 1012 switches odd-numbered output terminal and even-numbered output terminal synchronously with the field switching rate according to the input signal 1004 and output signal 1006 of the inverter 1006.

As description above, a new driving method and driving circuit of source driver according to the present invention can reduce flicker and crosstalk of image quality problem. The source driver circuit of the present invention only drives a half data lines in the display panel within one field time, therefore only a half of the driving circuit is required, which reduces necessary circuits.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of driving a plurality of data lines in a display, comprising:
dividing a frame into a first field and a second field; and
sequentially driving a first part of said data lines corresponding to said first field and driving a second part of said data lines corresponding to the second field, wherein while said data lines are driving, every two adjacent pixels are respectively applied with a first common voltage with a first polarity and applied with a second common voltage with a second polarity within a time period of said frame, wherein said first polarity is opposite to said second polarity, and wherein said first part and said second part of said data lines are interlaced arrangement.

2. The driving method of display of claim 1, wherein said first part of said data lines are odd-numbered data lines, and said second part of said data lines are even-numbered data lines, said data lines of said first part and said second part are interlaced to each other.

3. The driving method of display of claim 1, wherein said first part of said data lines are even-numbered data lines, and said second part of said data lines are odd-numbered data lines, said data lines of said first part and said second part are interlaced to each other.

4. A data driving circuit of a display, comprising;
a data processing circuit comprising a plurality of output terminals, said data processing circuit receiving a display data and outputting said display data through said output terminals;
a plurality of multiplexers, each of input terminals of said multiplexers is one-on-one coupled to one of said output terminals of said data processing circuit, each of said multiplexers comprising a first output terminal and a second output terminal, said first output terminal and said second output terminal being coupled to two adjacent data lines coupled to a display panel of said display; and
a control unit, providing a control signal to the multiplexers to control said multiplexers outputting said display data through said first output terminal or said second output terminal.

5. The data driving circuit of display of claim 4, wherein said multiplexer comprising:
a first switch, coupled to said input terminal of said multiplexer and coupled to said first output terminal; and
a second switch, coupled to said input terminal of said multiplexer and coupled to said second output terminal, wherein the first switch and the second switch are turned on or off by said control signal from said control unit.

6. The data driving circuit of display of claim 4, wherein the control unit control every said multiplexers to output said display data once separately from said first output terminal and said second output terminal with in a frame time.
